(19) United States
(12) Patent Application Publication
(10) Pub. No.: US 2006/0169808 A1
(43) Pub. Date: Aug. 3, 2006

(54) Method for treating recycled polyethylene terephthalate containing melting contaminants

(76) Inventors: Donald W. Hayward, Waterville, OH (US); Daniel L. Witham, Holland, OH (US)

Correspondence Address: FRASER MARTIN & MILLER LLC, 28366 KENSINGTON LANE, PERRYSBURG, OH, 43551, US

(21) Appl. No.: 10/549,776

(22) PCT Filed: Mar. 12, 2004
(86) PCT No.: PCT/US04/07568

§ 371 Date: Sep. 19, 2005

Related U.S. Application Data
(60) Provisional application No. 60/459,655, filed on Apr. 2, 2003.

(51) Int. Cl. B02C 21/00

(52) U.S. Cl. 241/23

(57) ABSTRACT

A process for treating RPET flakes comprises providing a quantity of RPET flakes having melting contaminants, comminuting the RPET flakes to prepare RPET particles having an average mean particle size less than about 300 microns, melting the RPET particles to prepare an RPET melt, and mixing the RPET melt.

### CROSS REFERENCE TO RELATED APPLICATION

This Application claims the benefit of U.S. Provisional Patent Application Ser. No. 60/459,655 filed on Apr. 2, 2003.

### FIELD OF THE INVENTION

This invention relates generally to a process for treating recycled polyethylene terephthalate (RPET) containing contaminants. More particularly, the invention is directed to a process for treating contaminated RPET, so that the small amounts of melting contaminants contained in the RPET flakes have a negligible effect on the article ultimately produced from the RPET melt.

### BACKGROUND OF THE INVENTION

Post-consumer processing of recycled PET to manufacture a variety of low-tech consumer products such as flower pots and fence posts is well-known. Typically, the recycling process utilizes used PET containers, such as discarded carbonated beverage containers, which are collected, sorted, washed, and separated from contaminants to yield a relatively clean source of RPET. Additionally, the manufacture of imperfect and damaged molded PET products, particularly the blow molded bottles used for containing consumer goods, results in a considerable amount of PET waste which the manufacturers of such products would like to reuse. The RPET produced by conventional recycling processes is generally in ground or flake form, which is thereafter melt processed or further pelletized by the end user.

RPET is generally subjected to a grinding operation in order to make the material easier to handle and process. Conventional grinding equipment reduces the RPET to about ⅜ inch particles or flakes. The grinding is conducted in a manner to insure that a consistent flake size will be produced, by employing a grate or screen through which the ground material must pass upon exiting the grinder. Although conventional RPET flakes melt processing and pelletizing equipment is designed to handle ⅜ inch flakes, some RPET materials having sizes as large as ½ inch and as small as ¼ inch are also commercially produced. The bulk density of ⅜ inch flake RPET generally ranges from about 22 to about 35 pounds per cubic foot.

Due to the nature of the recycling process, numerous polymeric contaminants are typically found in RPET flakes. These contaminants may be classified generally as either melting or non-melting contaminants. Melting contaminants are those which melt at or below the melting temperature of polyethylene terephthalate (PET), while non-melting contaminants are those which melt at temperatures above the melt temperature of PET. Examples of melting contaminants include PVC, Nylon, Polyethylene, Polypropylene, EVOH, Polystyrene, and the like.

It is known that melting contaminants degrade rapidly in the RPET melt stream of, for example, a melt extruder. Melting contaminants often cause yellowing and a loss of intrinsic viscosity in the RPET plastic stream. Likewise, such contaminants often form discrete areas of very dark inclusions or gels within the RPET plastic matrix.

It would be desirable to treat contaminated RPET, so that small amounts of melting contaminants would have only a negligible effect on RPET melting operations.

### SUMMARY OF THE INVENTION

Accordant with the present invention, a process for treating RPET flakes which contain melting contaminants, so that the melting contaminants have only a negligible effect during the RPET melting and forming operations, has surprisingly been discovered. The process comprises providing a quantity of RPET flakes having melting contaminants, comminuting the RPET flakes to prepare RPET particles having an average mean particle size less than about 300 microns, melting the RPET particles to prepare an RPET melt, and mixing the RPET melt. By the terminology “RPET flakes having melt contaminants” as used hereinabove is meant either RPET flakes mixed together with melting contaminants or RPET flakes containing imbedded contaminants. Accordingly, by the terminology “comminuting the RPET flakes” as used hereinabove is meant simultaneously comminuting the RPET flakes and the mixed or imbedded melting contaminants.

The inventive process is particularly useful for preparing a polymer melt from RPET flakes, which melt is ultimately used for the processing and forming of, for example, plastic containers.

### DETAILED DESCRIPTION OF THE PREFERRED EMBODIMENT

The present invention is directed to a process for treating RPET flakes, comprising providing a quantity of RPET flakes having melting contaminants, comminuting the RPET flakes to prepare RPET particles having an average mean particle size less than about 300 microns, melting the RPET particles to prepare an RPET melt, and mixing the RPET melt.

By the term “RPET flakes” as it is used herein is meant generally the commercially available recycled polyethylene terephthalate materials produced by conventional PET recycling methods, usually in flake form, but which may additionally be in the form of chunks, spheres, pellets, and the like, and which are generally made available in bulk in a substantially uniform particle size from about ¼ inch to about ½ inch.

According to the present invention, a quantity of RPET flakes containing melting contaminants is provided for further processing. The quantity of RPET flakes provided in the initial step of the inventive process may easily be determined by a routineer in the art of polymer processing, depending upon the quantity of polymer melt ultimately desired.

According to the present invention, the RPET flakes are comminuted by any conventional means to prepare RPET particles having an average mean particle size less than about 300 microns. Methods and apparatus for comminuting RPET and other polymer flakes are well known.

Following combination of the RPET flakes, the resultant RPET particles are melted by conventional means such as, for example, by adding the neet or pelletized RPET particles to a melt extruder, or to a high shear device. As will be readily apparent to one ordinarily skilled in the art, the melting contaminants are melted along with the RPET particles.

Finally, the RPET melt is thoroughly mixed together by conventional means. Conveniently, if a melt extruder or high shear device is used in the previous step, the mixing will occur substantially simultaneously with the mixing operation.

This polymer blend component is beneficial for combining with other polymer materials for subsequent melt processing and forming operations. For example, the addition of the inventive RPET melt to a quantity of virgin polyethylene terephthalate will extend the volume of the virgin PET.

If an RPET melt were prepared directly from the original RPET flakes, the resulting melt would be considered unusable or of low quality. The inventive process, however, converts this erstwhile useless RPET material into a higher grade of RPET which may even be useful for the manufacture of food grade containers.

The process for treating RPET flakes containing melting contaminants described hereinabove is generally disclosed in terms of its broadest application to the practice of the present invention. Occasionally, the process conditions as described may not be precisely applicable to each RPET/contaminant combination included within the disclosed scope. Those instances where this occurs, however, will be readily recognized by those ordinarily skilled in the art. In all such cases, the process may be successfully performed by conventional modifications to the disclosed method.

The invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope.

What is claimed is:

1. A process for treating RPET flakes, comprising:
providing a quantity of RPET flakes having melting contaminants;
comminuting the RPET flakes to prepare RPET particles having an average mean particle size less than about 300 microns;
melting the RPET particles, to prepare an RPET melt; and
mixing the RPET melt.

2. The process for treating RPET flakes according to claim 1, wherein the RPET flakes comprise chunks, spheres, pellets, or mixtures thereof.

3. The process for treating RPET flakes according to claim 1, wherein the RPET flakes have particle sizes from about ¼ inch to about ½ inch.

4. The process for treating RPET flakes according to claim 1, wherein the melting contaminants comprise Polyvinyl Chloride, Nylon, Polyethylene, Polypropylene, Ethyl Vinyl Alcohol, Polystyrene, or mixtures thereof.

5. The process for treating RPET flakes according to claim 1, wherein the RPET particles are melted in an extruder.

6. The process for treating RPET flakes according to claim 1, wherein the RPET particles are melted and the RPET melt is mixed simultaneously.
